(19) United States
(12) Patent Application Publication
(10) Pub. No.: US 2026/0246148 A1
(43) Pub. Date: Aug. 20, 2026

(54) WIDEBAND OMNIDIRECTIONAL SLEEVE DIPOLE ANTENNA

(71) Applicant: TE Connectivity Solutions GmbH, Schaffhausen (CH)

(72) Inventors: Rizwan KHAN, Penang (MY); KokJiunn NG, Penang (MY); Enchi LEE, Penang (MY); Chin Shen TAN, Penang (MY)

(21) Appl. No.: 19/218,704

(22) Filed: May 27, 2025

(30) Foreign Application Priority Data
Feb. 17, 2025 (MY) PI 2025001125

(51) Int. Cl. H01Q 9/28; H01Q 1/24; H01Q 1/38

(52) U.S. Cl. CPC H01Q 9/285; H01Q 1/241; H01Q 1/38

(57) ABSTRACT

An antenna includes a printed circuit board and an omnidirectional, multiband dipole antenna printed on a surface of the printed circuit board. The antenna may include one or more planar choke sleeves printed on the surface of the printed circuit board. The dipole antenna may be a triband antenna or a quadband antenna operable in the 2.4 GHz Wifi band, the 5 GHz Wifi band, and the 6 GHz Wifi band.

### CROSS REFERENCE TO RELATED APPLICATIONS

This application claims benefit to Malaysian Application No. PI 2025001125, filed 17 Feb. 2025, the subject matter of which is herein incorporated by reference in its entirety.

### BACKGROUND OF THE INVENTION

The subject matter herein relates generally to antennas.

Antennas are used in numerous wireless communication applications To allow communication between various devices. For example, wireless network access point devices, such as Wi-Fi routers and cellular base stations, rely on antennas to facilitate communication between user devices and the broader network infrastructure. The performance of these antennas is critical to ensuring reliable connectivity, high data throughput, and broad coverage.

Traditional network access points often employ complex multi antenna configurations to support advanced wireless technologies. Antenna designs are typically optimized for efficiency, gain, and signal directivity. However, achieving these performance objectives often results in intricate structures that require precise manufacturing techniques, specialized materials, and complex antenna design and assembly processes. As a result, the cost of production increases significantly, impacting both manufacturers and end users.

Additionally, space constraints within access point enclosures further complicate antenna design, necessitating compact yet highly efficient solutions. Current approaches frequently involve custom designed antennas that are difficult to integrate into standard manufacturing workflows, leading to increased production time and supply chain challenges.

There is a need for an improved antenna design for wireless network devices that reduces manufacturing complexity and cost while maintaining or enhancing wireless performance.

### BRIEF DESCRIPTION OF THE INVENTION

In an embodiment, an antenna is provided including a printed circuit board having a first surface and a second surface and an omnidirectional, multiband dipole antenna printed on the first surface of the printed circuit board. The dipole antenna includes a first dipole antenna element on the first surface and a second dipole antenna element on the first surface. The first and second dipole antenna elements are shaped differently for operation in different frequency bands.

In another embodiment, an antenna assembly is provided for a wireless communication device. The antenna assembly includes an antenna feed including a feed conductor and a ground conductor and an antenna coupled to the antenna feed. The antenna includes a printed circuit board having a first surface and a second surface and an omnidirectional, multiband dipole antenna printed on the first surface of the printed circuit board. The dipole antenna including a first dipole antenna element on the first surface coupled to the feed conductor of the antenna feed and a second dipole antenna element on the first surface coupled to the ground conductor of the antenna feed. The first and second dipole antenna elements shaped differently for operation in different frequency bands.

In a further embodiment, a wireless communication device is provided including a radome having walls forming a cavity and an antenna assembly received in the cavity. The antenna assembly includes an antenna feed including a feed conductor and a ground conductor and an antenna coupled to the antenna feed. The antenna includes a printed circuit board having a first surface and a second surface and an omnidirectional, multiband dipole antenna printed on the first surface of the printed circuit board. The dipole antenna including a first dipole antenna element on the first surface coupled to the feed conductor of the antenna feed and a second dipole antenna element on the first surface coupled to the ground conductor of the antenna feed. The first and second dipole antenna elements shaped differently for operation in different frequency bands.

In one embodiment, an antenna is provided including a printed circuit board and an omnidirectional, multiband dipole antenna printed on a surface of the printed circuit board.

In various embodiments, the antenna may include a planar choke sleeve printed on the surface of the printed circuit board. The antenna may include planar choke sleeves printed on the surface of the printed circuit board operable in different frequency bands.

Optionally, the dipole antenna may be a triband antenna or a quadband antenna operable in the 2.4 GHz Wifi band, the 5 GHz Wifi band, and the 6 GHz Wifi band.

In various embodiments, the dipole antenna is a sleeve dipole antenna.

Optionally, the dipole antenna includes a first antenna element and a second antenna element. The first and second antenna elements are shaped differently for operation in different frequency bands.

In various embodiments, the dipole antenna has an efficiency greater than 70% across the 2.4 GHz Wifi band, the 5 GHz Wifi band, and the 6 GHz Wifi band. In various embodiments, the dipole antenna has a VSWR less than 2:1 across the 2.4 GHz Wifi band, the 5 GHz Wifi band, and the 6 GHz Wifi band.

Optionally, the printed circuit board includes a rigid, planar substrate having a first side and a second side, wherein the dipole antenna being printed on the first side and a feed cable is coupled to the dipole at the first side.

Optionally, the printed circuit board includes a flexible substrate configured to be arranged in a non-planar orientation.

In various embodiments, the dipole antenna includes a low band radiator and a high band radiator. The low band radiator may include a first arm and a second arm and the high band radiator may be located between the first and second arms and separated from the first and second arms by first and second slots. Optionally, the dipole antenna includes a high band extension extending beyond the first and second arms of the low band radiator. The high band extension may include first and second arms separated by a gap. Optionally, distal ends of the first and second arms include fingers bent inward toward each other.

In various embodiments, the antenna includes a choke element printed on the printed circuit board. The choke element may be U-shaped having first and second choke arms connected by a connecting base.

WiFi is one of the most important applications of the wireless communication technology. WiFi uses 2.4G/5G/6G Frequency bands. To integrate all of these bands into one device a Tri-band antenna or Quad-band antenna is provided. The frequency range covered by the antenna may be from 2.4-2.5 Ghz and 5.15-7.125 GHz, such as a Triband in the application of WiFi 6E or a Quad band in the application of WiFi 7.

It is desirable to provide antenna having a high efficiency and a good radiation pattern across the frequency bands. It is also desirable that the antenna maintains its size so that it can fit into the compact radome/housing.

In various embodiments, a method of introducing a printed choke sleeve between the broadband omnidirectional printed dipole antenna and the feeding coaxial line is proposed to restrain the radiation patterns tilting in E-plane, thus enhancing the omnidirectional gains in H-plane and improving the impedance bandwidth.

A problem of conventional omnidirectional dipole antennas is the difficulty in arranging both of the antenna elements. This is because the excitation is physically on the same axis, which blocks the way of the feeding network. And it also contributes to the degradation of antenna radiation performance.

In an embodiment, a multiband antenna is provided including a pair of lower band arm and a single arm for the upper band. All of these arms are printed on the same layer of substrate and excited by a simple coaxial cable. The compactness of the dual-band antenna may be achieved by bending the arm of low band and chamfering the edges of dipole elements. Chamfering of the antenna elements helps to improve the impedance bandwidth of a high band frequencies.

It is noticed during the design stage that the current intensity on the coaxial cable is much higher at specific frequency region. In various embodiments, the current intensity may be reduced due to the introduction of a planar choke sleeve, which restrains the deteriorate of reflection coefficient and preventing the tilting of patterns in E-plane and improving the gains in H-plane.

In an embodiment, an antenna is provided having efficiency quite consistent across the whole frequency range which is averaged >70%. The antenna has the VSWR<2:1 for all the three bands which is considered as a low reflection. Due to the controlled radiation pattern antenna shows a good gain performance. Embodiments of the antenna provide a good radiation pattern across the triband or quadband frequency range.

In an embodiment, an antenna is provided usable with a WLAN access point with a triband or quadband frequency range. The antenna total dimension may be approximately 131 mm×21 mm, which includes the radome and the connector itself. The dimension of the antenna PCB may be approximately 71.6 mm×16.6 mm×0.8 mm. The antenna may have the advantages of a relatively simple structure (because a single sided PCB is used to accommodate the dipole, chokes and feeding), wider resonance bandwidth in a radiation frequency band, as well as low cost. The antenna can realize triband or quadband operation without extra installation space. The antenna is not just limited to the said dimension it can be optimized to small or big based on the application requirements. The choke can also be of different shape and size. The antenna may also be suitable for the unit to form an antenna array due to its steady structure and high scalability.

### BRIEF DESCRIPTION OF THE DRAWINGS

FIG. 1 illustrates a wireless communication device in accordance with an exemplary embodiment.

FIG. 2 illustrates a portion of the wireless communication device in accordance with an exemplary embodiment.

FIG. 3 illustrates a portion of the wireless communication device in accordance with an exemplary embodiment.

FIG. 4 is an exploded view of a portion of the wireless communication device in accordance with an exemplary embodiment.

FIG. 5 is a front, assembled view of a portion of the wireless communication device in accordance with an exemplary embodiment.

FIG. 6 is a front view of the antenna in accordance with an exemplary embodiment.

FIG. 7 is a front, assembled view of a portion of the wireless communication device in accordance with an exemplary embodiment.

FIG. 8 is a front, assembled view of a portion of the wireless communication device in accordance with an exemplary embodiment.

FIG. 9 is a front, assembled view of a portion of the wireless communication device in accordance with an exemplary embodiment.

FIG. 10 is a front, assembled view of a portion of the wireless communication device in accordance with an exemplary embodiment.

FIG. 11 is a front, assembled view of a portion of the wireless communication device in accordance with an exemplary embodiment.

FIG. 12 is a front, assembled view of a portion of the wireless communication device in accordance with an exemplary embodiment.

FIG. 13 is a front, assembled view of a portion of the wireless communication device in accordance with an exemplary embodiment.

FIG. 14 is a front, assembled view of a portion of the wireless communication device in accordance with an exemplary embodiment.

FIGS. 15-30 provide measured results for the antenna assembly in accordance with the embodiment shown in FIG. 4.

### DETAILED DESCRIPTION OF THE INVENTION

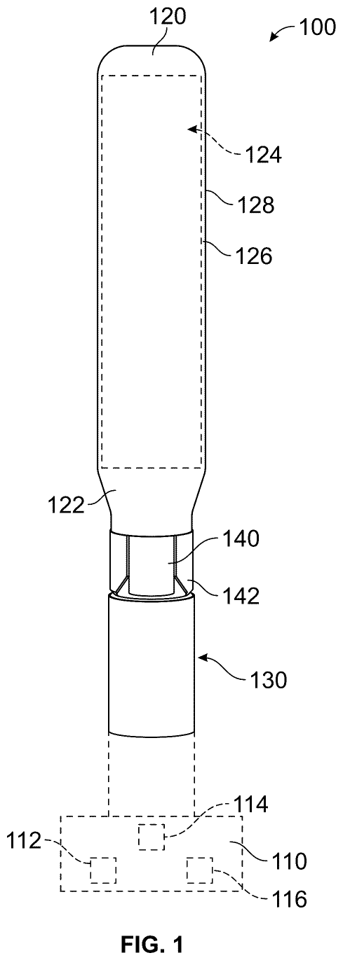

FIG. 1 illustrates a wireless communication device 100 in accordance with an exemplary embodiment. The wireless communication device 100 is configured to be coupled to an electrical component 110. The wireless communication device 100 is configured to transmit and/or receive wireless communication to/from the electrical component 110. The electrical component 110 may be a network component, a computer component, or other type of system or device. The wireless communication device 100 and the electrical component 110 may be used in mobile devices, routers, or other wireless communication devices requiring multi-band operation.

In an exemplary embodiment, the wireless communication device 100 is a wireless access point (WAP) for the electrical component 102. In an exemplary embodiment, the electrical component 110 includes a processor 112, a communication module 114 (such as a Wi-Fi or Bluetooth module), and a power supply 116. The electrical component 110 can include various devices or systems that are electronically controlled, such as sensors, actuators, or other connected components within an industrial, residential, or commercial environment.

The wireless communication device 100 is communicatively coupled to the communication module 114 to allow wireless connection with one or more remote devices, such as to facilitate remote communication, data transfer, monitoring, control, or configuration of the components of the system. The system enables seamless integration and management of electrical components by providing a secure and reliable communication interface for data exchange, system diagnostics, and operational command instructions. The wireless communication device 100 can be positioned at a location that ensures optimal wireless signal strength and coverage for the electrical component 110.

The wireless communication device 100 includes a radome 120 housing or covering an antenna assembly 200. The radome 120 includes walls 122 forming a cavity 124 that receives the antenna assembly 200. In an exemplary embodiment, the radome 120 is a multipiece structure. For example, the radome 120 includes a front housing 126 and a rear housing 128 connected together to form the cavity 124 and surround the antenna assembly 200.

In an exemplary embodiment, the wireless communication device 100 includes a connector 130 at an end of the radome 120. For example, the connector 130 may be provided at the bottom of the radome 120. The connector 130 is configured to be connected to the electrical component 110. In various embodiments, the connector 130 may be directly connected to the electrical component 110. In other embodiments, the connector 130 may be connected to the electrical component 110 by an intermediary component, such as a coaxial cable. In an exemplary embodiment, the connector 130 is a female connector, such as a socket connector. For example, the connector 130 may include a threaded receptacle configured to be threadably coupled to a male connector of the electrical component 110.

In an exemplary embodiment, the wireless communication device 100 may include an articulation region allowing the wireless communication device 100 to be arranged at different orientations relative to the electrical component 110. For example, the wireless communication device 100 may be oriented at different angular positions relative to the electrical component 110. In an exemplary embodiment, wireless communication device 100 includes an upper knuckle 140 and a lower knuckle 142 movable relative to each other. The upper knuckle 140 is coupled to the radome 120. For example, the radome 120 may be threadably coupled to the upper knuckle 140. The lower knuckle 142 is coupled to the connector 130. The upper knuckle 140 may be debited or rotated relative to the lower knuckle 142. Other types of articulation devices may be used to allow movement of the wireless communication device 100 relative to the electrical component 110.

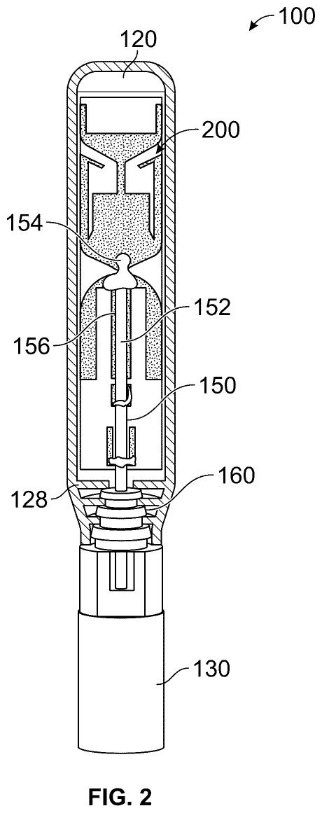

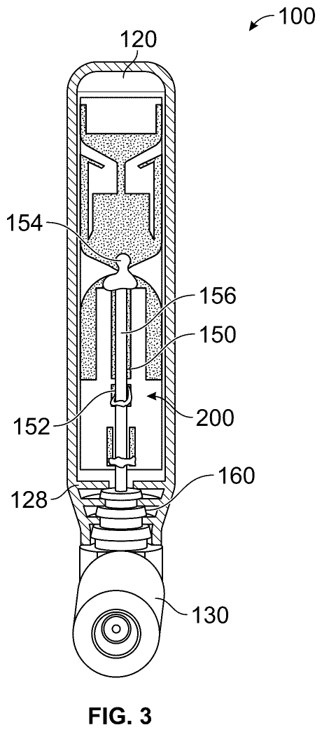

FIG. 2 illustrates a portion of the wireless communication device 100 in accordance with an exemplary embodiment. FIG. 3 illustrates a portion of the wireless communication device 100 in accordance with an exemplary embodiment. FIGS. 2 and 3 illustrate the radome 120 with the front housing 126 removed to illustrate the antenna assembly 200. FIG. 2 shows the connector 130 in a first orientation (for example, straight or 180° orientation). FIG. 3 shows the connector 130 in a second orientation (for example, right angle or 90° orientation). Other orientations are possible in alternative embodiments.

In an exemplary embodiment, the wireless communication device 100 includes an antenna feed 150 configured to deliver RF signals to the antenna assembly 200. The antenna feed 150 may be connected to the connector 130 and/or the electrical component 110. In the illustrated embodiment, the antenna feed 150 includes a coaxial cable 152. Other types of antenna feed may be used in alternative embodiments such as a microstrip line, a waveguide, a twin lead, a balance line, and the like. In an exemplary embodiment, the antenna feed 150 includes a feed conductor 154 and a ground conductor 156. The feed conductor 154 and the ground conductor 156 are configured to be coupled to the antenna assembly 200. In the illustrated embodiment of the coaxial cable 152, the feed conductor 154 is a center conductor of the coaxial cable 152 and the ground conductor 156 is an outer conductor or cable braid of the coaxial cable 152. The antenna feed 150 may be designed using a variety of impedance matching techniques to ensure efficient power transfer to the various antenna elements of the antenna assembly 200. The antenna feed 150 may be optimized to support multi-band operation, ensuring that the various antenna elements resonate at their respective frequency band(s) while minimizing interference between the multiple bands.

In an exemplary embodiment, a grommet 160 supports the coaxial cable 152 relative to the radome 120. The grommet 160 may be a rubber grommet. The grommet 160 may be compressible. The grommet 160 may provide a sealed interface between the front and rear housings 126, 128 of the radome 120.

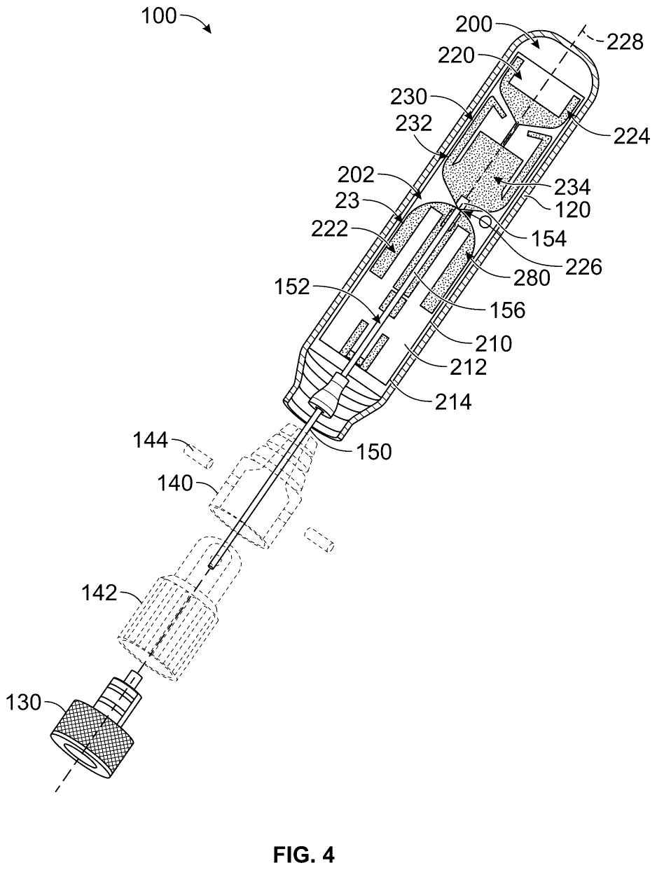

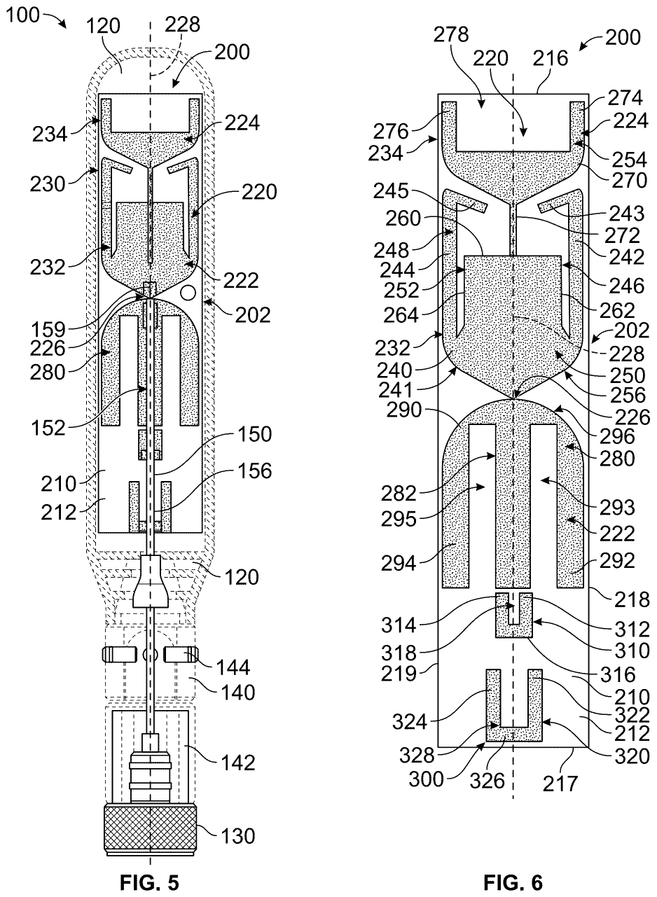

FIG. 4 is an exploded view of a portion of the wireless communication device 100 in accordance with an exemplary embodiment. FIG. 5 is a front, assembled view of a portion of the wireless communication device 100 in accordance with an exemplary embodiment. The wireless communication device 100 includes the radome 120, the connector 130, the upper knuckle 140, the lower knuckle 142, and the antenna assembly 200. FIGS. 4 and 5 show the radome 120 without the front housing 126 to illustrate the antenna assembly 200.

The radome 120 receives the antenna assembly 200. The radome 120 is configured to be coupled to the upper knuckle 140. The connector 130 is configured to be coupled to the lower knuckle 142. In an exemplary embodiment, the upper knuckle 140 is configured to be coupled to the lower knuckle 142 via pivot pins 144.

The antenna assembly 200 includes the antenna feed 150 and an antenna 202 coupled to the antenna feed 150. In the illustrated embodiment, the antenna feed 150 includes the coaxial cable 152. In various embodiments, the coaxial cable 152 may be an RG 178 coaxial cable. The coaxial cable 152 is configured to pass through the upper knuckle 140 and the lower knuckle 142 for connection to the connector 130 or another component connected to the connector 130. In various embodiments, the connector 130 may be an RP-SMA connector configured to operate at approximately 8 GHz. However, other types of connectors may be used in alternative embodiments.

The antenna 202 includes a printed circuit board (PCB) 210 and a dipole antenna 220 arranged on the printed circuit board 210. The dipole antenna 220 includes one or more low-band antenna elements 222 and one or more high-band antenna elements 224 integrated onto the PCB 210. The low-band antenna element 222 is a portion of the dipole antenna 220 designed to resonate at lower frequencies, such as in the WiFi 2.4 GHz band and/or the WiFi 5 GHz band or other low-frequency wireless communication ranges. The low-band antenna element 222 is optimized for lower frequency signals and may consist of a longer length trace relative to the high-band antenna element 224. The high-band antenna element 224 is designed to resonate at higher frequencies, such as in the WiFi 5 GHz band and/or the WiFi 6 GHz band or other high-frequency communication standards. The high-band antenna element 224 is typically a shorter length trace compared to the low-band element.

The antenna 202 is designed to support multi-band operation, offering low-frequency and high-frequency communication capabilities within the same compact structure. The configuration of the antenna 202 allows for optimized performance in the multiple frequency bands while minimizing the overall size of the antenna assembly 200. The multiple antenna elements supporting the multiple frequency bands are integrated into a single device and are incorporated into the single PCB 210, such as on a single side of the PCB 210 to provide a low cost and efficient antenna. The antenna 202 has high efficiency and a good radiation pattern across the multiple frequency bands. For example, the antenna 202 provides an omnidirectional radiation pattern. The antenna 202 has a small size to fit in the compact size of the radome 120. The low-band antenna element 222 may be designed to achieve a wide bandwidth in the lower frequency range. The high-band antenna element 224 may be designed to achieve high efficiency and low loss in the higher frequency range. The antenna elements 222, 224 may be optimized for minimal size while maintaining high radiation efficiency and omnidirectional radiation pattern. The multi-band dipole antenna 220 is integrated onto the single PCB 210, which enables a compact and efficient design that occupies less space compared to traditional discrete antennas. In an exemplary embodiment, the antenna elements 222, 224 of the dipole antenna 220 are provided on a single side of the PCB 210 to provide a low cost of manufacturing, particularly compared to antenna assemblies providing antenna elements on both sides of the PCB. In an exemplary embodiment, the antenna assembly 200 incorporates choke elements, such as printed sleeve choke elements, along the antenna feed to restrain the radiation patterns, such as from tilting in the E-plane, thus enhancing the omnidirectional gains in the H-plane and improving the impedance bandwidth. The choke elements may be designed to reduce current intensity at specific frequency regions. The choke elements may restrain the deteriorate of reflection coefficient and prevent the tilting patterns in the E-plane and improve the gains in the H-plane.

In an embodiment, an antenna 202 is provided usable with a WLAN access point with a triband or quadband frequency range. The antenna total dimension may be approximately 131 mm×21 mm, which includes the radome and the connector itself. The dimension of the antenna PCB may be approximately 71.6 mm×16.6 mm×0.8 mm. The antenna 202 may have the advantages of a relatively simple structure (because a single sided PCB is used to accommodate the dipole, chokes and feeding), wider resonance bandwidth in a radiation frequency band, as well as low cost. The antenna 202 can realize triband or quadband operation without extra installation space. The antenna 202 is not just limited to the said dimension it can be optimized to small or big based on the application requirements. The choke elements can also be of different shape and size. The antenna 202 may also be suitable for the unit to form an antenna array due to its steady structure and high scalability.

In an exemplary embodiment, the antenna 202 is a multiband antenna. In various embodiments, the antenna 202 may be a triband antenna or a quadband antenna. For example, the antenna 202 may be operable in the 2.4-GHz WiFi band (2.4-2.5 GHz), one or more of the 5-GHz WiFi bands (5.17 to 5.835 GHz), and the 6-GHz WiFi band (5.925 to 7.125). In an exemplary embodiment, the antenna 202 is a multiband dipole antenna. In various embodiments, the antenna 202 is a sleeve dipole antenna being end fed by the antenna feed with the sleeve design helping to minimize the influence of the antenna feed on the antennas radiation pattern leading to improved signal quality. In an exemplary embodiment, the antenna 202 is a printed dipole antenna, such as a printed sleeve dipole antenna. In an exemplary embodiment, the antenna 202 includes a pair of low band arms and a high band arm, which are designed for operation at the 2.4-GHz band (2.4-2.5 GHz), the 5-GHz band (5.17 to 5.835 GHz), and the 6-GHz band (5.925 to 7.125), respectively. The antenna 202 may incorporate impedance matching elements to ensure that the impedance of the antenna 202 matches the impedance of the transmission line or RF circuit, such as at 50 ohms, to control signal reflection and improve the efficiency of the antenna 202.

With additional reference to FIG. 6, which is a front view of the antenna 202 in accordance with an exemplary embodiment, the antenna 202 includes the dipole antenna 220 printed on the PCB 210. For example, the dipole antenna 220 is defined by printed circuits of the PCB 210 on one or more layers of the PCB 210. In an exemplary embodiment, the dipole antenna 220 is printed on a single layer of the PCB 210, such as the front surface of the PCB 210 to eliminate the need for trace routing, vias, and other processes that increase the expense of manufacturing of the PCB 210 thus providing a low cost antenna.

The PCB 210 provides the structural base for the dipole antenna 220. In various embodiments, the PCB 210 is a rigid substrate. The PCB 210 may be made from a material such as FR4 (Flame Retardant 4) or a similar dielectric material suitable for RF (radio frequency) applications. The PCB 210 may be made from other materials in alternative embodiments. In various embodiments, the PCB 210 may be a flexible circuit allowing the antenna 202 to be manipulated into a shape configured to conform to the radome 120. For example, the flexible circuits of the antenna 202 may be wrapped into a generally cylindrical shape. The flexible circuit can fit into a rounded shape or any other shape of housing. The PCB 210 is designed with the necessary conductive layers to integrate the antenna elements. The PCB 210 includes a first surface 212 and a second surface 214 opposite the first surface 212. The first surface 212 may be a front surface and the second surface 214 may be a rear surface. The PCB 210 extends between a top 216 and a bottom 217. The PCB 210 may include opposite right and left sides 218, 219 between the top 216 and the bottom 217. The sides 218, 219 may be parallel to each other. In the illustrated embodiment, the PCB 210 is generally rectangular being elongated in the height direction wherein the height the PCB 210 between the top 216 and the bottom 217 is longer than the width of the PCB 210 between the sides 218, 219. The PCB 210 may have other shapes in alternative embodiments.

In an exemplary embodiment, the PCB 210 may include a ground plane, such as at the second surface 214 or at an internal layer of the PCB 210, to enhance the performance of the antenna, particularly for the low-band antenna element(s) 222. The PCB 210 may incorporate a dielectric substrate layer designed to further optimize the antenna's 202 performance by minimizing signal loss and enhancing bandwidth.

In an exemplary embodiment, the dipole antenna 220 includes a first dipole antenna element 230 on the first surface 212 and a second dipole antenna element 280 on the first surface 212. The first and second dipole antenna elements 230, 280 are shaped differently for operation in different frequency bands. The spacing or separation between the first and second dipole antenna elements 230, 280 is designed to control matching in the high band, such as at the 7 GHz range. In an exemplary embodiment, the first and second dipole antenna elements 230, 280 meet at a feed point 226 on the first surface 212. The feed point 226 may be located along the central longitudinal axis 228 of the dipole antenna 220. The antenna feed 150 may extend along and be coupled to the dipole antenna 220 along the longitudinal axis 228. The first dipole antenna element 230 is configured to be coupled to the feed conductor 154 of the antenna feed 150 (for example, the center conductor of the coaxial cable 152). For example, the feed conductor 154 may be soldered to the first dipole antenna element 230. The second dipole antenna element 280 is configured to be coupled to the ground conductor 156 of the antenna feed 150 (for example, the outer conductor or cable grade of the coaxial cable 152). For example, the ground conductor 156 may be soldered to the second dipole antenna element 280. In the illustrated embodiment, the first dipole antenna element 230 is located above the second dipole antenna element 280. For example, the first dipole antenna element 230 extends between the feed point 226 and the top 216 of the PCB 210 and the second dipole antenna element 280 extends between the feed point 226 and the bottom 217 of the PCB 210.

In an exemplary embodiment, the first dipole antenna element 230 includes a low band resonator 232 and a high band resonator 234 configured to resonate in different frequency bands. In an exemplary embodiment, the second dipole antenna element 280 includes a resonator 282 configured to resonate in a different frequency band than the low band resonator 232 and the high band resonator 234. The first dipole antenna element 230 and/or the second dipole antenna element 280 may include additional resonators in alternative embodiments.

In an exemplary embodiment, the low band resonator 232 includes a base 240 at the feed point 226, a first low band arm 242 at a first side of the low band resonator 232, and a second low band arm 244 at a second side of the low band resonator 232. The base 240 spreads outward from the feed point 226 toward the first and second sides 218, 219 of the PCB 210. Optionally, the base 240 may occupy approximately the entire width of the PCB 210. In an exemplary embodiment, the base 240 includes chamfers 241 at the feed point 226. The chamfers 241 spread away from the second dipole antenna element 280. The chamfers 241 may be angled and/or curved from the feed point 226. The chamfering improves the impedance bandwidth of the high band frequencies and impedance matching.

The first low band arm 242 extends from the base 240 toward the top 216 of the PCB 210. The first low band arm 242 may be located at or proximate to the first side 218 of the PCB 210. The first low band arm 242 has a length selected to correspond to a 1/4 wavelength for the low band resonator 232. In an exemplary embodiment, the distal end of the first low band arm 242 is bent inward forming a first low band finger 243, which increases the overall length of the low band resonator 232 without increasing the overall height of the PCB 210.

The second low band arm 244 extends from the base 240 toward the top 216 of the PCB 210. The second low band arm 244 may be located at or proximate to the second side 219 of the PCB 210. The second low band arm 244 has a length selected to correspond to a 1/4 wavelength for the low band resonator 232. In an exemplary embodiment, the distal end of the second low band arm 244 is bent inward forming a second low band finger 245, which increases the overall length of the low band resonator 232 without increasing the overall height of the PCB 210.

In an exemplary embodiment, the first dipole antenna element 230 includes a first slot 246 between the first low band arm 242 and the high band resonator 234 and a second slot 248 between the second low band arm 244 and the high band resonator 234 forming a sleeve arrangement to constrain the resonance. The slots 246, 248 separate the low band resonator 232 from the high band resonator 234. The lengths and/or widths of the slots 246, 248 affect the antenna characteristics of the first dipole antenna element 230, such as to control the frequency bands of the low band resonator 232 and/or the high band resonator 234. The slots 246, 248 are introduced to increase the current path by increasing the electrical length of the antenna 202, particularly for the low band. The arrangement of the low band arms 242, 244, such as the bending inward, and extending along the high band resonator 234 provides a compact antenna arrangement. The low band arms 242, 244 may be bent inward to achieve a target resonance, such as at the low band of 2.4 GHz and to reduce the overall size of the antenna 202.

The high band resonator 234 includes a base 250 at the feed point 226 and a high band base portion 252 at the front of the base 250. In an exemplary embodiment, the high band resonator 234 includes a high band extension portion 254 extending from the high band base portion 252. The base 250 spreads outward from the feed point 226 toward the first and second sides 218, 219 of the PCB 210. Optionally, the base 250 may occupy approximately the entire width of the PCB 210. In an exemplary embodiment, the base 250 includes chamfers 256 at the feed point 226. The chamfers 256 spread away from the second dipole antenna element 280. The chamfers 256 may be angled and/or curved from the feed point 226. The chamfering improves the impedance bandwidth of the high band frequencies and impedance matching. In various embodiments, the base 250 of the high band resonator 234 may be coincident with or defined by the same structure as the base 240 of the low band resonator 232.

The high band base portion 252 extends to a top edge 260. The high band extension portion 254 extends upward from the top edge 260 and is located above the high band base portion 252. The high band base portion 252 has opposite the first and second side edges 262, 264 extending between the top edge 260 and the base 250. The first and second side edges 262, 264 face the first and second slots 246, 248. For example, the first and second side edges 262, 264 face the first and second low band arms 242, 244 across the slots 246, 248. In the illustrated embodiment, the first and second side edges 262, 264 are parallel to each other and parallel to the longitudinal axis 228. The first and second side edges 262, 264 may be parallel to the first and second low band arms 242, 244. The size and shape of the high band base portion 252 affect the antenna characteristics of the first dipole antenna element 230, such as to control the frequency band(s) of the high band resonator 234. For example, the height of the high band base portion 252 between the feed point 226 and the top edge 260 may be selected to correspond to a 1/4 wavelength for the high band resonator 234.

The high band extension portion 254 is located at the top of the first dipole antenna element 230. For example, the high band extension portion 254 is located between the high band base portion 252 and the top 216 of the PCB 210. In the illustrated embodiment, the low band fingers 243, 245 extend into the gap or space between the high band base portion 252 and the high band extension portion 254. In an exemplary embodiment, the high band extension portion 254 includes an extension base 270 and a connecting leg 272 between the extension base 270 and the high band base portion 252. The connecting leg 272 is narrow and passes between the low band arms 242, 244. The extension base 270 widens relative to the connecting leg 272. For example, the extension base 270 may flared outward toward the first and second sides 218, 219 of the PCB 210. Optionally, the extension base 270 may occupy approximately the entire width of the PCB 210. The high band extension portion 254 enhances the bandwidth of the high band frequencies, such as at the 6 GHz band. The high band extension portion 254 improves the azimuth gain of the antenna 202.

In an exemplary embodiment, the high band extension portion 254 includes a first extension arm 274 and a second extension arm 276 extending from the extension base 270. In the illustrated embodiment, the extension arms 274, 276 extend upward from the extension base 270 toward the top 216 of the PCB 210. The extension arms 274, 276 provide bandwidth enhancement, particularly at the high band. The extension arms 274, 276 improve the radiation pattern of the high band. A gap 278 is defined between the extension arms 274, 276. The gap 278 is located above the extension base 270. In the illustrated embodiment, the extension arms 274, 276 are located at or proximate to the first and second sides 218, 219 of the PCB 210. The high band extension portion 254 may have other shapes in alternative embodiments, such as without the extension arms 274, 276.

In an exemplary embodiment, the resonator 282 of the second dipole antenna element 280 includes a base 290 at the feed point 226, a central leg 291 extending from the base 290, a first leg 292 at a first side of the resonator 282, a second leg 294 at a second side of the resonator 282. The base 290 spreads outward from the feed point 226 toward the first and second sides 218, 219 of the PCB 210. Optionally, the base 290 may occupy approximately the entire width of the PCB 210. In an exemplary embodiment, the base 290 includes chamfers 296 at the feed point 226. The chamfers 296 spread away from the first dipole antenna element 230. The chamfering improves the impedance bandwidth of the high band frequencies and impedance matching. The chamfers 296 may be angled and/or curved from the feed point 226.

The central leg 291 extends along the central longitudinal axis 228 of the PCB 210. The central leg 290 one extends downward from the base 290. In an exemplary embodiment, first and second slots 293, 295 are defined between the central leg 290 and the first and second legs 292, 294, respectively. The slots 293, 295 separate the first and second legs 292, 294 from the central leg 290. The lengths and/or widths of the slots 293, 295 affect the antenna characteristics of the second dipole antenna element 280, such as to control the frequency bands of the resonator 282. The slots 293, 295 help in tuning the antenna 202 and impedance matching of the antenna 202. In the illustrated embodiment, the central leg 290 is generally rectangular having parallel side edges extending to a distal end of the central leg 290. The size and shape of the central leg 291 affects the antenna characteristics of the second dipole antenna element 280, such as to control the frequency band(s) of the resonator 282. For example, the height of the central leg 291 between the feed point 226 and the bottom or distal edge thereof may be selected to correspond to a ¼ wavelength for the resonator 282.

The first leg 292 extends from the base 290 toward the bottom 217 of the PCB 210. The first leg 292 may be located at or proximate to the first side 218 of the PCB 210. The first leg 292 has a length (for example, height) selected to correspond to a ¼ wavelength for the resonator 282. The height of the first leg 292 may be equal to the height of the central leg 291. However, the first leg 292 may be longer or shorter than the central leg 291 in alternative embodiments. In various embodiments, the distal end of the first leg 292 may be bent inward to increase the overall length of the resonator 282 without increasing the overall height of the PCB 210.

The second leg 294 extends from the base 290 toward the bottom 217 of the PCB 210. The second leg 294 may be located at or proximate to the second side 219 of the PCB 210. The second leg 294 has a length (for example, height) selected to correspond to a ¼ wavelength for the resonator 282. The height of the second leg 294 may be equal to the height of the central leg 291. However, the second leg 294 may be longer or shorter than the central leg 291 in alternative embodiments. In various embodiments, the distal end of the second leg 294 may be bent inward to increase the overall length of the resonator 282 without increasing the overall height of the PCB 210.

In an exemplary embodiment, the antenna 202 includes one or more choke elements 300. For example, in the illustrated embodiment, the dipole antenna 220 includes a low band choke element 310 and a high band choke element 330. The choke elements 300 are used to control and prevent unwanted RF (radio frequency) signals from propagating along unintended paths, often referred to as RF leakage or backfeed. The low band choke element 310 operates at a lower frequency band (for example, 2.4 GHz or 5 GHz) and the high band choke element 320 operates at a higher frequency band (for example, 5 GHz or 6 GHz). The choke element(s) 300 help improve the overall performance, efficiency, and operation of the antenna 202. The choke element(s) 300 are configured to be coupled to the ground conductor 156 of the antenna feed 150 (for example, the outer conductor or cable grade of the coaxial cable 152). For example, the ground conductor 156 may be soldered to the choke element(s) 300. The choke elements 300 may be printed choke elements printed on the same plane as the first and second dipole antenna elements 230, 280.

In an exemplary embodiment, the low band choke element 310 is U-shaped. For example, the low band choke element 310 includes first and second choke arms 312, 314 connected by a connecting base 316. A gap 318 is defined between the first and second choke arms 312, 314. In the illustrated embodiment, the gap 318 is located above the connecting base 316. For example, the choke arms 312, 314 extend upward from the connecting base 316. The size and shape of the low band choke element 310 affect the choke characteristics of the low band choke element 310, such as to control the frequency band(s) of the low band choke element 310. For example, the height of the choke arms 312, 314 and/or the width of the connecting base 316 and/or the width of the gap 318 may be selected to control the choke characteristics of the low band choke element 310. The low band choke element 310 may have other shapes in alternative embodiments.

In an exemplary embodiment, the high band choke element 320 is U-shaped. For example, the high band choke element 320 includes first and second choke arms 322, 324 connected by a connecting base 326. A gap 328 is defined between the first and second choke arms 322, 324. In the illustrated embodiment, the gap 328 is located above the connecting base 326. For example, the choke arms 322, 324 extend upward from the connecting base 326. The size and shape of the high band choke element 320 affect the choke characteristics of the high band choke element 320, such as to control the frequency band(s) of the high band choke element 320. For example, the height of the choke arms 322, 324 and/or the width of the connecting base 326 and/or the width of the gap 328 may be selected to control the choke characteristics of the high band choke element 320. The high band choke element 320 may have other shapes in alternative embodiments.

In an exemplary embodiment, the choke elements 310, 320 are aligned with the longitudinal axis 228. The choke elements 310, 320 are configured to be electrically connected to the antenna feed 150, such as to the ground conductor 156. In the illustrated embodiment, the low band choke element 310 is located above the high band choke element 320. For example, the low band choke element 310 may be located proximate to the second dipole antenna element 280 and the high band choke element 320 may be located proximate to the bottom 217 of the PCB 210. Optionally, the high band choke element 320 may be spaced apart from the low band choke element 310, such as being separated by a gap. Alternatively, the low band choke element 310 may be proximate to or embedded in the high band choke element 320, such as in the gap 328. Other locations are possible in alternative embodiments.

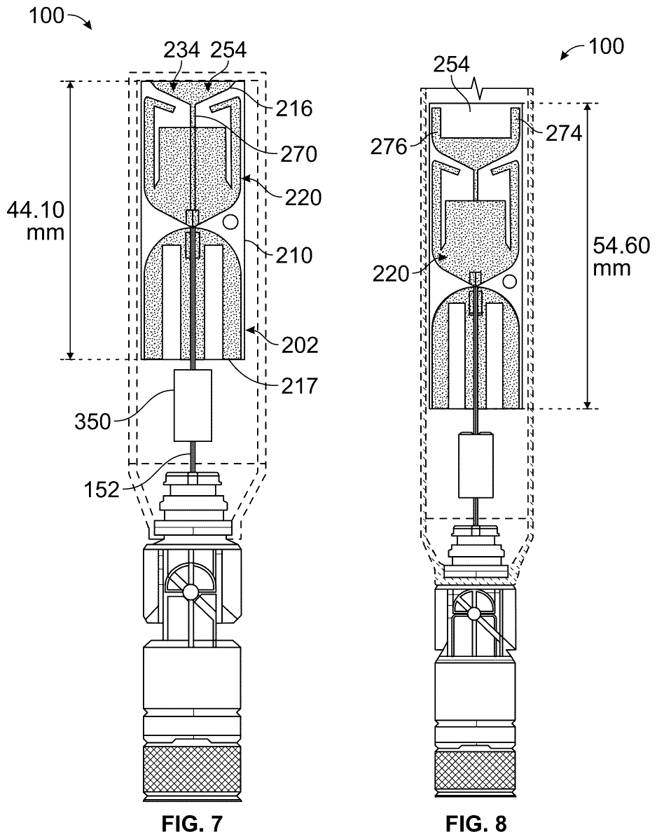

FIG. 7 is a front, assembled view of a portion of the wireless communication device 100 in accordance with an exemplary embodiment. The embodiment shown in FIG. 7 is similar to the embodiment shown in FIG. 4; however, the dipole antenna 220 is sized and shaped differently. For example, the PCB 210 has a reduced height and the dipole antenna 220 extends substantially the entire height, such as between the top 216 and the bottom 217. In the illustrated embodiment, the high band resonator 234 includes the high band extension portion 254 with the extension base 270, but does not include the first and second extension arms 274, 276 (FIG. 4). The dipole antenna 220 shown in FIG. 7 may be operable at a lower frequency band than the dipole antenna 220 shown in FIG. 4.

In the illustrated embodiment, the antenna assembly 200 does not include the choke elements 300. In contrast, the antenna assembly 200 includes a cylindrical choke 350 surrounding the coaxial cable 152.

FIG. 8 is a front, assembled view of a portion of the wireless communication device 100 in accordance with an exemplary embodiment. The embodiment shown in FIG. 8 is similar to the embodiment shown in FIG. 7; however, the dipole antenna 220 is sized and shaped differently. For example, the PCB 210 has an increased height and the high band extension portion 254 includes the first and second extension arms 274, 276 extending from the extension base 270. The dipole antenna 220 shown in FIG. 8 may be operable at a higher frequency band than the dipole antenna 220 shown in FIG. 7.

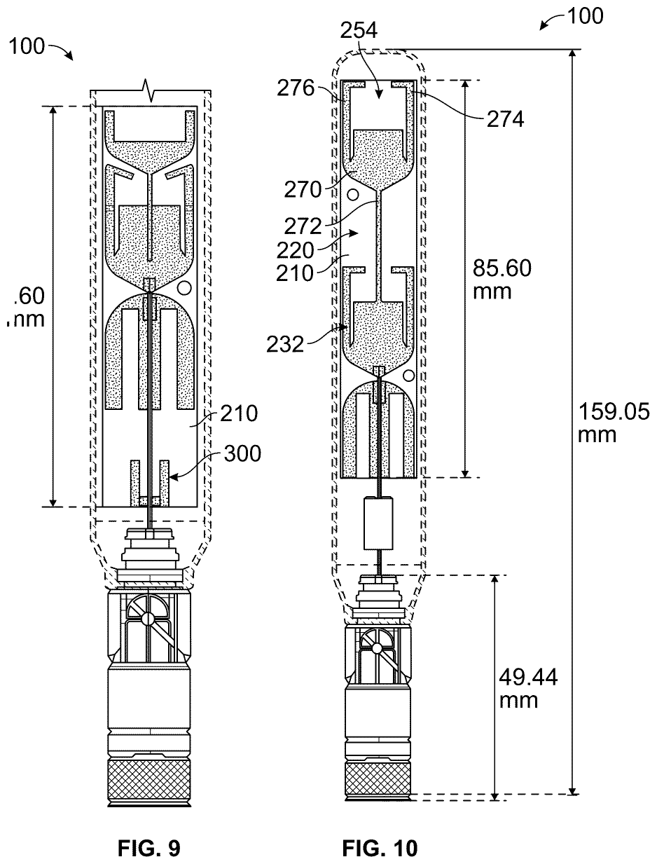

FIG. 9 is a front, assembled view of a portion of the wireless communication device 100 in accordance with an exemplary embodiment. The embodiment shown in FIG. 9 is similar to the embodiment shown in FIG. 8; however, the antenna assembly includes one of the choke elements 300 on the PCB 210 rather than the cylindrical choke 350 (FIG. 8).

FIG. 10 is a front, assembled view of a portion of the wireless communication device 100 in accordance with an exemplary embodiment. The embodiment shown in FIG. 10 is similar to the embodiment shown in FIG. 8; however, the dipole antenna 220 is sized and shaped differently. For example, the PCB 210 has an increased height and the high band extension portion 254 is elongated compared to the embodiment shown in FIG. 8. For example, the connecting leg 272 is elongated to position the extension base 270 further from the low band resonator 232. The first and second extension arms 274, 276 of the high band extension portion 254 are elongated and include fingers bent inward to further increase the lengths of the high band extension portion for operation at even higher frequency. The extension base 270 is elongated and includes slots between the extension arms 274, 276 to target additional frequency bands.

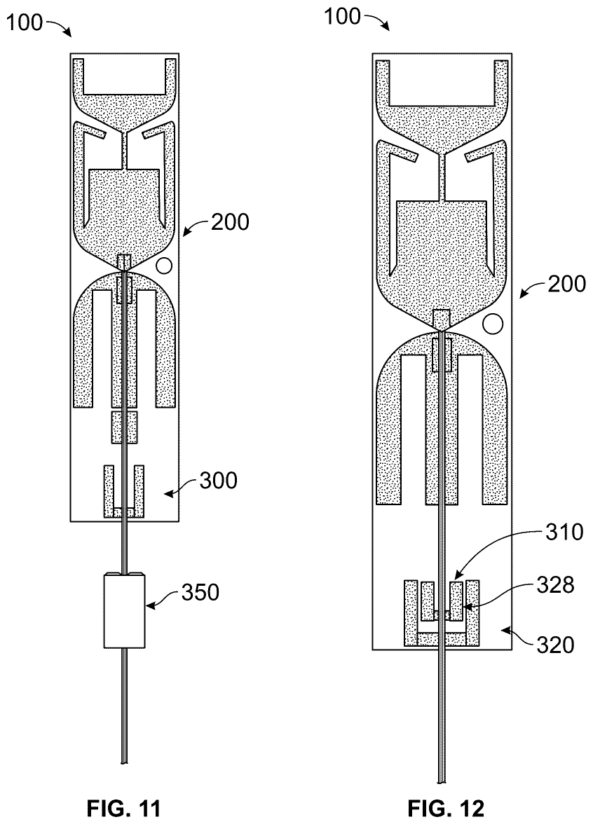

FIG. 11 is a front, assembled view of a portion of the wireless communication device 100 in accordance with an exemplary embodiment. The embodiment shown in FIG. 11 is similar to the embodiment shown in FIG. 7; however, the antenna assembly 200 includes both the printed planar choke element 300 and the cylindrical choke element 350.

FIG. 12 is a front, assembled view of a portion of the wireless communication device 100 in accordance with an exemplary embodiment. The embodiment shown in FIG. 12 is similar to the embodiment shown in FIG. 4; however, the antenna assembly 200 includes the low band choke element 310 and the high band choke 320 internested with each other. For example, the low band choke element 310 is located in the gap 328 of the high band choke element 320.

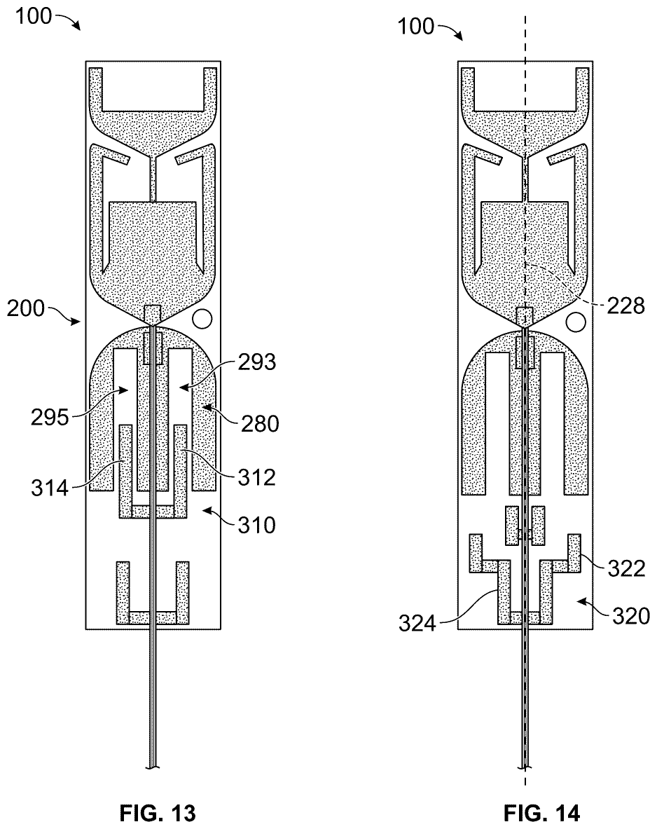

FIG. 13 is a front, assembled view of a portion of the wireless communication device 100 in accordance with an exemplary embodiment. The embodiment shown in FIG. 13 is similar to the embodiment shown in FIG. 4; however, the antenna assembly 200 includes the low band choke element 310 internested within the sleeve of the second dipole element 280. For example, the first and second choke arms 312, 314 are located in the first and second slots 293, 295, respectively.

FIG. 14 is a front, assembled view of a portion of the wireless communication device 100 in accordance with an exemplary embodiment. The embodiment shown in FIG. 14 is similar to the embodiment shown in FIG. 4; however, the high band choke element 320 has a different shape. For example, the first and second choke arms 322, 324 are elongated and may include jogged sections to increase the lengths of the choke arms 322, 324. The choke arms 322, 324 are symmetrical about the longitudinal axis 228. The high band choke element 320 may have other shapes in alternative embodiments.

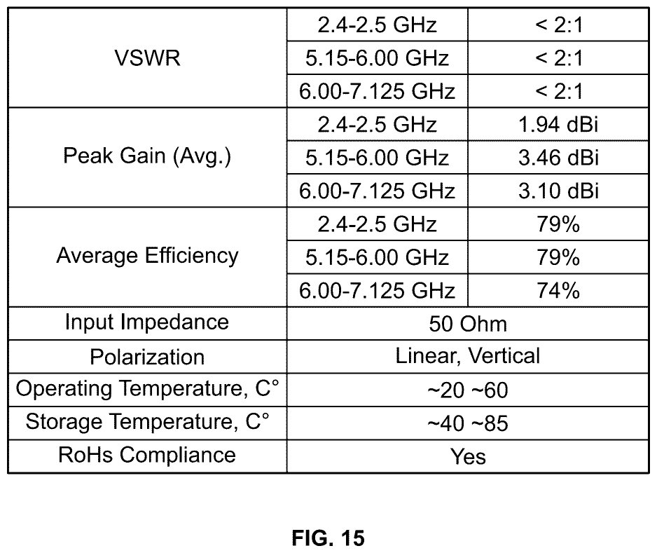

FIGS. 15-30 provide measured results for the antenna assembly 200 in accordance with the embodiment shown in FIG. 4. In an exemplary embodiment, the antenna assembly 200 is a multi-band antenna assembly designed to cover multiple frequency bands, such as the 2.4-GHz WiFi band (2.4-2.5 GHz), one or more of the 5-GHz WiFi bands (5.17 to 5.835 GHz), and the 6-GHz WiFi band (5.925 to 7.125). The antenna assembly 200 may be designed to cover other frequency bands in alternative embodiments. In an exemplary embodiment, the antenna assembly 200 has a VSWR less than 2:1 in the 2.4-GHz WiFi band, in the 5-GHz WiFi band, and in the 6-GHz WiFi band. In various embodiments, the antenna assembly 200 has a peak gain of 1.94 dBi in the 2.4-GHz WiFi band, a peak gain of 3.46 dBi in the 5-GHz WiFi band, and a peak gain of 3.10 dBi in the 6-GHz WiFi band. In various embodiments, the antenna assembly 200 has an average efficiency of 79% in the 2.4-GHz WiFi band, an average efficiency of 79% in the 5-GHz WiFi band, and an average efficiency of 74% in the 6-GHz WiFi band. The analysis results shown in FIGS. 15-30 are provided for purposes of illustration and not for purposes of limitation. Alternative embodiments of antenna assemblies may be configured differently and have different operational or performance parameters and/or frequency ranges than what is shown in FIGS. 15-30.

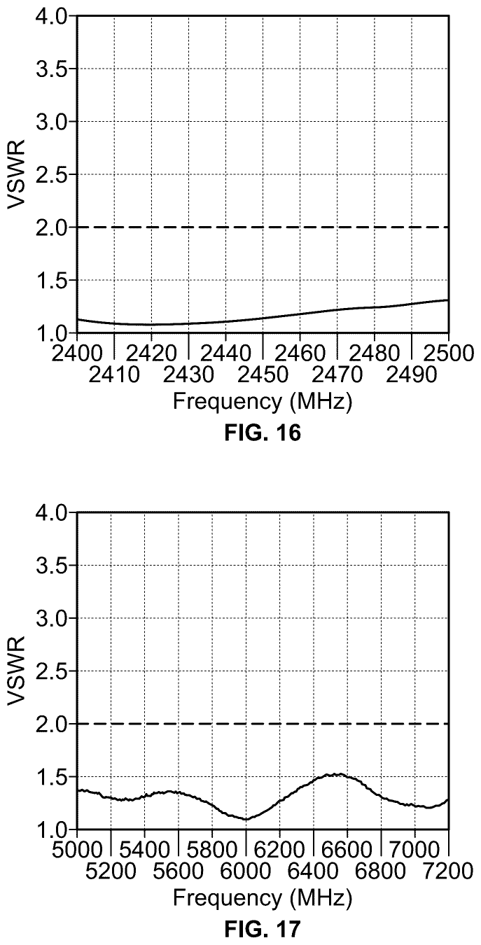

FIG. 16 shows VSWR results for the antenna assembly 200 in the 2.4-GHz WiFi band. FIG. 17 shows VSWR results for the antenna assembly 200 in the 5-GHz WiFi band and the 6-GHz WiFi band. The antenna assembly 200 has a VSWR less than 2:1 in the 2.4-GHz WiFi band, in the 5-GHz WiFi band, and in the 6-GHz WiFi band.

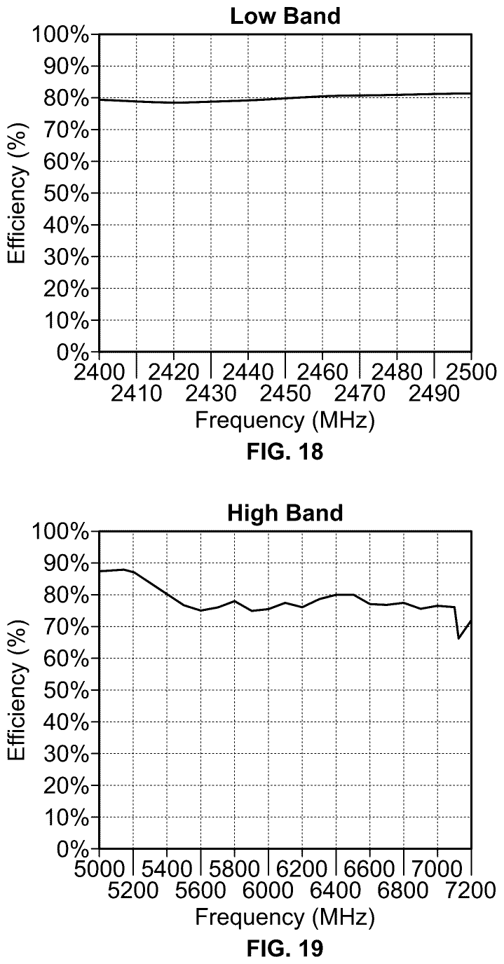

FIG. 18 shows efficiency results for the antenna assembly 200 in the 2.4-GHz WiFi band. FIG. 19 shows efficency results for the antenna assembly 200 in the 5-GHz WiFi band and the 6-GHz WiFi band. The antenna assembly 200 has an average efficiency of 79% in the 2.4-GHz WiFi band, an average efficiency of 79% in the 5-GHz WiFi band, and an average efficiency of 74% in the 6-GHz WiFi band.

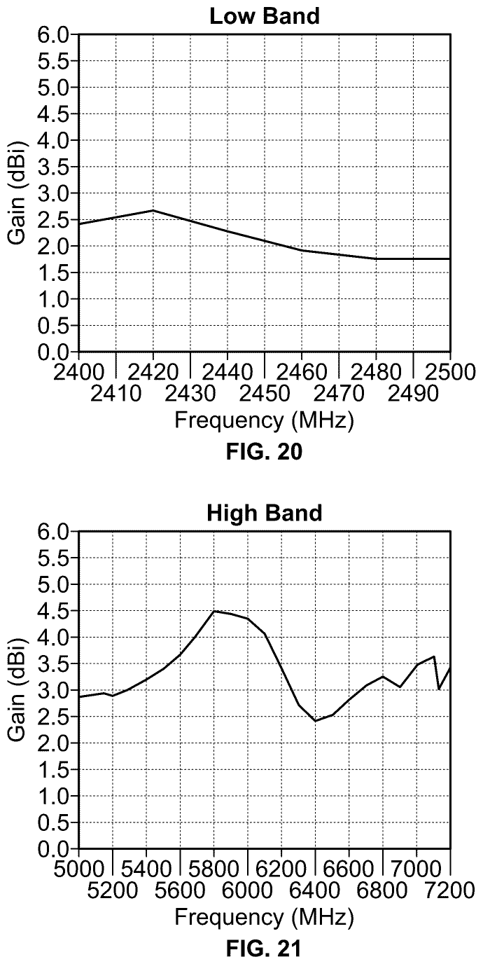

FIG. 20 shows gain results for the antenna assembly 200 in the 2.4-GHz WiFi band. FIG. 21 shows gain results for the antenna assembly 200 in the 5-GHz WiFi band and the 6-GHz WiFi band. The antenna assembly 200 has a peak gain of 1.94 dBi in the 2.4-GHz WiFi band, a peak gain of 3.46 dBi in the 5-GHz WiFi band, and a peak gain of 3.10 dBi in the 6-GHz WiFi band.

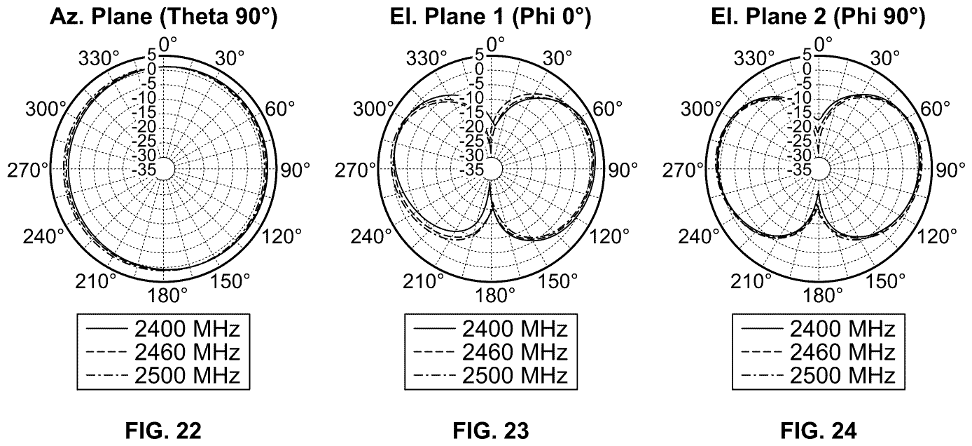

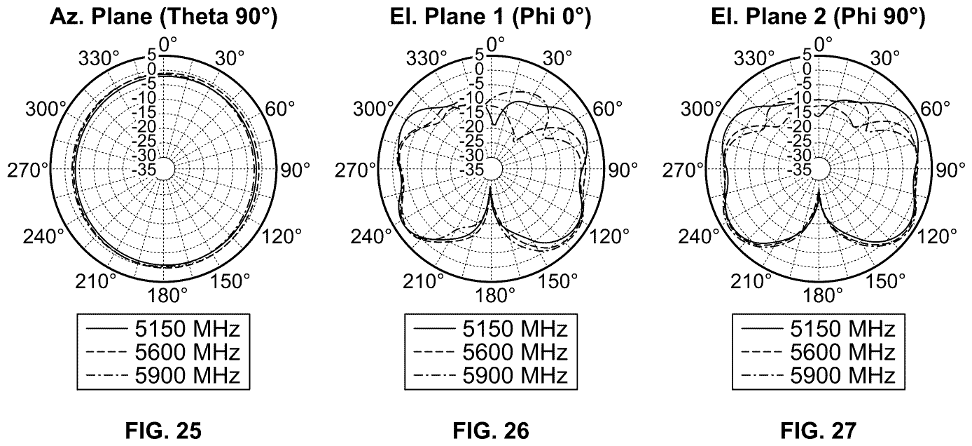

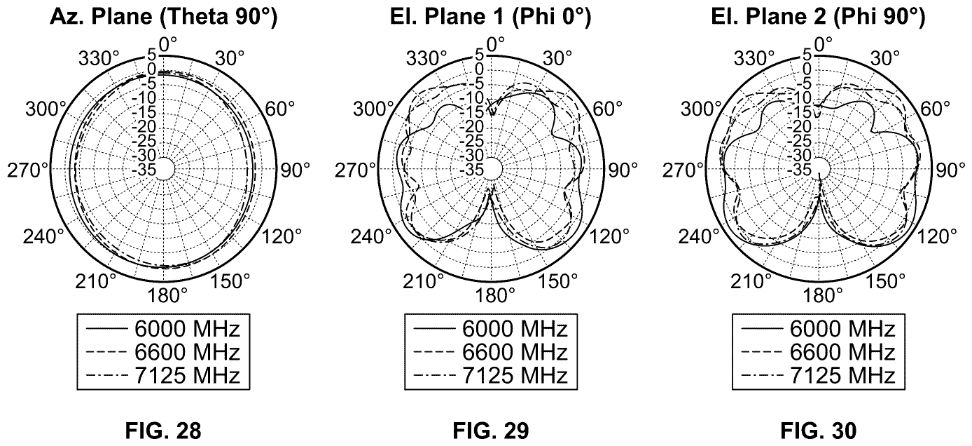

FIGS. 22-24 show radiation patterns for the antenna assembly 200 in the 2.4-GHz WiFi band. FIGS. 25-27 show radiation patterns for the antenna assembly 200 in the 5-GHz WiFi band. FIGS. 28-30 show radiation patterns for the antenna assembly 200 in the 6-GHz WiFi band.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

1. An antenna comprising:
a printed circuit board having a first surface and a second surface; and
an omnidirectional, multiband dipole antenna printed on the first surface of the printed circuit board, the dipole antenna including a first dipole antenna element on the first surface and a second dipole antenna element on the first surface, the first and second dipole antenna elements shaped differently for operation in different frequency bands.

2. The antenna of claim 1, further comprising a planar choke sleeve printed on the surface of the printed circuit board.

3. The antenna of claim 1, further comprising planar choke sleeves printed on the surface of the printed circuit board operable in different frequency bands.

4. The antenna of claim 1, wherein the dipole antenna is one of a triband antenna or a quadband antenna operable in the 2.4 GHz Wifi band, the 5 GHz Wifi band, and the 6 GHz Wifi band.

5. The antenna of claim 1, wherein the first dipole antenna element is a sleeve dipole antenna element including first and second arms extending along opposed sides of the first dipole antenna element, and wherein the second dipole antenna element is a sleeve dipole antenna element including first and second arms extending along opposed sides of the second dipole antenna element.

6. The antenna of claim 1, wherein the first dipole antenna element includes a low band resonator and a high band resonator configured to resonate in different frequency bands.

7. The antenna of claim 6, wherein the low band radiator includes a first arm and a second arm, the high band radiator located between the first and second arms and separated from the first and second arms by first and second slots.

8. The antenna of claim 7, wherein the high band radiator includes a high band base portion located between the first and second arms of the low band radiator and a high band extension portion extending from the high band base portion, the high band extension portion extending beyond the first and second arms of the low band radiator.

9. The antenna of claim 8, wherein the high band extension portion includes first and second extension arms separated by a gap.

10. The antenna of claim 7, wherein distal ends of the first and second arms of the low band radiator include fingers bent inward toward each other.

11. The antenna of claim 1, wherein the first and second dipole antenna elements meet at a feed point on the first surface, a feed cable coupled to the first and second dipole antenna elements at the feed point.

12. The antenna of claim 11, wherein the first dipole antenna element includes a first dipole base at the feed point, the first dipole base being chamfered from the feed point, and wherein the second dipole antenna element includes a second dipole base at the feed point, the second dipole base being chamfered from the feed point.

13. The antenna of claim 1, wherein the printed circuit board includes a rigid, planar substrate.

14. The antenna of claim 1, wherein the printed circuit board includes a flexible substrate configured to be arranged in a non-planar orientation.

15. The antenna of claim 1, further comprising a choke element printed on the printed circuit board, the choke element being U-shaped having first and second choke arms connected by a connecting base.

16. The antenna of claim 1, wherein the dipole antenna has an efficiency greater than 70% across the 2.4 GHz Wifi band, the 5 GHz Wifi band, and the 6 GHz Wifi band.

17. The antenna of claim 1, wherein the dipole antenna has a VSWR less than 2:1 across the 2.4 GHz Wifi band, the 5 GHz Wifi band, and the 6 GHz Wifi band.

18. An antenna assembly for a wireless communication device, the antenna assembly comprising:
an antenna feed including a feed conductor and a ground conductor; and
an antenna coupled to the antenna feed, the antenna including a printed circuit board having a first surface and a second surface and an omnidirectional, multiband dipole antenna printed on the first surface of the printed circuit board, the dipole antenna including a first dipole antenna element on the first surface coupled to the feed conductor of the antenna feed and a second dipole antenna element on the first surface coupled to the ground conductor of the antenna feed, the first and second dipole antenna elements shaped differently for operation in different frequency bands.

19. The antenna assembly of claim 18, wherein the antenna includes a planar choke sleeve printed on the surface of the printed circuit board.

20. A wireless communication device comprising:
a radome having walls forming a cavity; and
an antenna assembly received in the cavity, the antenna assembly including an antenna coupled to an antenna feed, the antenna feed including a feed conductor and a ground conductor, the antenna including a printed circuit board having a first surface and a second surface, the antenna including an omnidirectional, multiband dipole antenna printed on the first surface of the printed circuit board, the dipole antenna including a first dipole antenna element on the first surface coupled to the feed conductor of the antenna feed and a second dipole antenna element on the first surface coupled to the ground conductor of the antenna feed, the first and second dipole antenna elements shaped differently for operation in different frequency bands.
